(19) United States
(12) Patent Application Publication
(10) Pub. No.: US 2013/0082933 A1
(43) Pub. Date: Apr. 4, 2013

(54) MOBILE COMPUTER WITH KEYPAD-EMBEDDED RFID ANTENNA

(71) Applicants: Xiaotao Liang, East Northport, NY (US); Nisha K. Kunder, New York, NY (US); Dean V. LaRosa, Bohemia, NY (US); Edward M. Voli, East Setauket, NY (US)

(72) Inventors: Xiaotao Liang, East Northport, NY (US); Nisha K. Kunder, New York, NY (US); Dean V. LaRosa, Bohemia, NY (US); Edward M. Voli, East Setauket, NY (US)

(73) Assignee: Symbol Technologies, Inc., Holtsville, NY (US)

(21) Appl. No.: 13/252,236

(22) Filed: Oct. 4, 2011

(51) Int. Cl. G06F 3/02

(52) U.S. Cl. 345/169

(57) ABSTRACT

A mobile computer is described. The mobile computer includes a memory for storing a software application. A processor is coupled to the memory for executing the software application. A display is coupled to the processor for graphically displaying information generated by the software application. A keypad is coupled to the processor for receiving input from a user. The keypad is positioned adjacent to the display. A radio-frequency identification (RFID) antenna is embedded in a portion of the keypad. The RFID antenna includes at least one conductor forming at least one loop for communicating with a RFID device to receive information from the RFID device.

### TECHNICAL FIELD

The invention relates generally to a mobile computer having an integrated radio frequency identification (RFID) antenna.

### BACKGROUND

Mobile computing terminals having integrated RFID technologies allow users to bring objects having RFID tags proximate to the terminal in order to read information contained within the tag or write information to the tag. However, the tag must be placed within a few millimeters of the typical RFID antenna in order to be read/write since the antenna cannot generate sufficient field strength to communicate with RFID tags placed further away. Conventional RFID antennas are wrapped around the display of the mobile terminal. Thus, in order to read/write a tag embedded in an object, the object must substantially obscure the display, thereby making the display difficult to view. Another conventional approach is to embed the RFID antenna within a battery cover on the back of the mobile terminal. This approach requires that the user change her normal grip on the mobile terminal in order to read/write a tag embedded in an object.

### SUMMARY

In one aspect, the invention is embodied in a mobile computer. The mobile computer includes a memory for storing a software application. A processor is coupled to the memory for executing the software application. A display is coupled to the processor for graphically displaying information generated by the software application. A keypad is coupled to the processor for receiving input from a user. The keypad is positioned adjacent to the display. A radio-frequency identification (RFID) antenna is embedded in a portion of the keypad. The RFID antenna includes at least one conductor forming at least one loop for communicating with a RFID device to receive information from the RFID device.

The RFID device can include a RFID tag. In one embodiment, the at least one conductor substantially surrounds the keypad. The at least one conductor can be a pair of conductors that form first and second concentric loops. The at least one conductor can be positioned proximate to a top surface of a plurality of keycaps of the keypad. The at least one conductor can be a wire or a conductive trace deposited on a surface of the keypad. In one embodiment, the antenna can also embody a flex PC board (PCB) positioned above the keypad PCB.

In one embodiment, a housing supports the memory, the processor, the display, the keypad, and the RFID antenna. The display can include a liquid crystal display (LCD). The mobile computer can also include a RFID transceiver coupled to the RFID antenna for communicating wirelessly with the RFID device.

In another aspect, the invention is embodied in a keypad. The keypad includes a keypad frame. Multiple keycaps are supported by the keypad frame. A circuit board includes a plurality of contact domes. Each of the keycaps is aligned with a corresponding contact dome on the circuit board. A RFID antenna including at least one conductor forms at least one loop that substantially surrounds the plurality of keycaps. The at least one conductor is mechanically coupled to the keypad frame.

The RFID device can include a RFID tag. In one embodiment, the at least one conductor includes a pair of conductors that form first and second concentric loops. The at least one conductor can be positioned proximate to a top surface of the plurality of keycaps of the keypad. The keypad can include a keypad housing for supporting the keypad frame, the plurality of keycaps, the circuit board, and the RFID antenna.

The at least one conductor can be a wire or a conductive trace deposited on a surface of the frame. A RFID transceiver can be coupled to the RFID antenna for communicating wirelessly with the RFID device.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments.

In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a block diagram illustrating an exemplary mobile computer including a keypad having an embedded antenna according to an embodiment of the invention.

FIG. 2 is a front view of a mobile computer including a keypad having an embedded RFID antenna according to an embodiment of the invention.

FIG. 3 is perspective view of an exemplary keypad having an embedded antenna according to an embodiment of the invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to radio-frequency identification technology, need not, and are not, described in detail herein.

Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions described herein. The non-processor circuits may include, but are not limited to, a radio receiver, a radio transmitter, signal drivers, clock circuits, power source circuits, and user input devices. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Technologies and concepts discussed herein relate to mobile computers having radio frequency identification (RFID) capability. In one exemplary embodiment, a mobile computer includes a keypad having a RFID antenna embedded therein. The RFID antenna can be wrapped around the perimeter of the keypad, or the antenna may be embedded in a portion of the keypad.

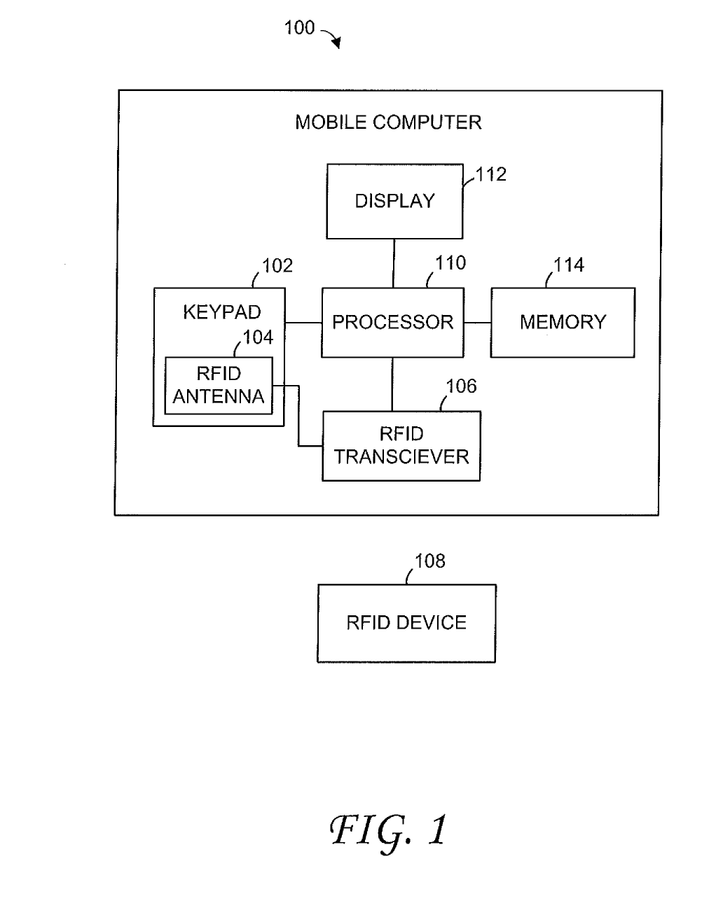

FIG. 1 is a block diagram illustrating an exemplary mobile computer 100 including a keypad 102 having an embedded antenna 104 according to an embodiment of the invention. The mobile computer 100 also includes a RFID transceiver 106 that receives signals from the RFID antenna 104 and transmits signals to a RFID device 108 via the RFID antenna 104. The RFID device 108 can be a RFID tag. For example, the RFID tag can be embedded in a credit card, an identification card, a passport, a key fob, and a wallet.

The antenna 104 can be embedded in a portion of keypad 102. In one embodiment, the antenna 104 includes a conducting loop that substantially surrounds the keypad 102. The antenna 104 is described in more detail herein. The RFID transceiver 106 is coupled to the antenna and receives signals received from the RFID device 108 via the antenna 104. For example, the RFID transceiver 106 can receive transaction information, such as the account number and an identifier from the RFID device 108. The mobile computer 100 can transmit this information to a credit card issuer associated with the RFID device 108 along with the amount due for a particular transaction. The issuer validates the transaction using the information received from the mobile computer 100 and sends a message to the mobile computer 100 indicating that the transaction was successfully completed. A processor 110 can direct a display 112 to display a message to the user indicating that the transaction was successfully completed.

The display 112 can graphically display information to a user. The display 112 can be any suitable graphical display, such as a liquid crystal display (LCD) that can include a thin film transistor (TFT) material.

The processor 110 can control the operation of the RFID transceiver 106 by executing a software application stored in memory 114. The memory 114 can be any suitable memory, such as a flash memory or a secure disk (SD) card memory.

In one embodiment, the RFID transceiver 106 and the processor 110 can be semiconductor components mounted on a printed circuit board within the mobile device 100. In an alternate embodiments, the RFID transceiver 106 and the processor 110 and any other electronic components of the mobile computer 100 can be separate components.

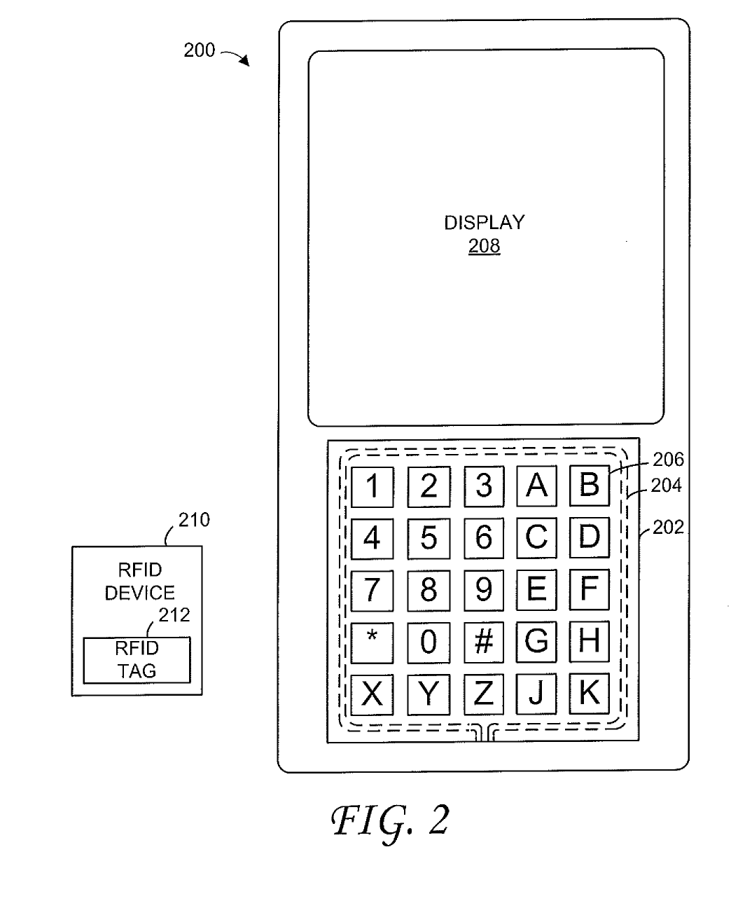

FIG. 2 is a front view of a mobile computer 200 including a keypad 202 having an embedded RFID antenna 204 according to an embodiment of the invention. The keypad 202 can include a plurality of keys 206. The mobile computer 200 also includes a display 208. The display 208 can be a touch screen display. In one embodiment, the keypad 202 is positioned adjacent to the display 208.

A RFID device 210 including a RFID tag 212 is positioned over the keys 206 of the keypad 202 to communicate with the antenna 204 embedded in the keypad 202 of the mobile device 200. The display 208 can graphically display information relating to the communication with the RFID device 210. The information can be directly viewed by a user of the RFID device 210 since the display 208 is not obstructed by the RFID device 210.

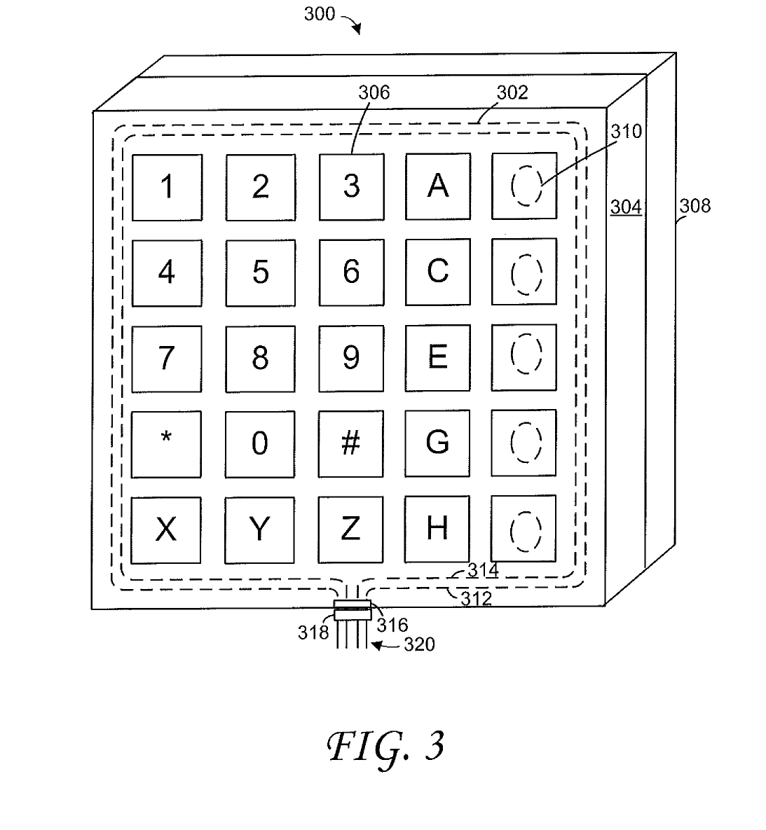

FIG. 3 is perspective view of an exemplary keypad 300 having an embedded antenna 302 according to an embodiment of the invention. The keypad 300 can include a frame 304. The frame 304 can support a plurality of keycaps 306. The keypad 300 can also include a circuit board 308. The circuit board 308 can include a plurality of contact domes 310. Each keycap 306 is aligned with a corresponding contact dome 310. The contact dome 310 is activated when an associated keycap 306 is depressed.

The antenna 302 can be embedded in the keypad 300. The antenna 302 includes two conductors 312 and 314 that form concentric loops. Conductors 312 and 314 can be traces of a metal oxide material that are deposited on a surface of a printed circuit board or another substrate during the manufacturing process. In an alternate implementation, conductors 312 and 314 may be wires that are adhesively attached to a surface of the frame 304 of the keypad 300. In order to hide conductors 312 and 314, the wires can be attached on the underside of the frame 304. Conductors 312 and 314 can terminate at a connector 316 that mates with a connector 318 having conductors 320, which connect the RFID antenna 302 to the RFID transceiver 106 (FIG. 1).

In one embodiment, the RFID transceiver 106 can be integrated with the circuit board 308 of the keypad 300. This provides an exchangeable RFID solution when the keypad 300 is replaced.

The RFID antenna 302 can communicate with RFID devices, such as RFID-enabled credit cards, identification cards, fobs, or phones, via a magnetic or electric field. In one embodiment, eddy currents on the nearby ground plane (i.e., the keypad PCB) can be produced by the antenna 302 when communicating with a RFID device via a magnetic field. These eddy currents absorb power, and lead to detuning of the antenna due to a decreased inductance and quality factor. In order to reduce these eddy currents, a ferrite shield (not shown) can be placed over conductors 312 and 314 to shield the antenna from the metallic environment. The ferrite generates an additional field component, which results in a fixed detuning of the antenna itself.

The embodiments described above relate to an antenna embedded in the keypad of a mobile computer for receiving information from a user. For example, the antenna may be used to collect payment, process tickets, coupons, or other information or transaction from a user.

In operation, the display 208 (FIG. 2) can display a graphical indication that the user should position the RFID device 210 over the keypad 202. Additionally, the display 208 can illustrate advertisements, coupons, or other information relating to a commercial transaction.

When the user brings the RFID device 210 proximate to the keypad 202, the antenna 204 can read transaction information from the RFID device 210 and/or write information to the RFID device 210. The display 208 can display status information to the user. For example, the status information can relate to whether the RFID device 210 was properly read by the mobile device 200 and/or written to by the mobile device 200.

Additionally, the user can be prompted for additional information. For example, the user could be prompted to enter a personal identification number (PIN) or a date of birth using the keypad 202 or a touch screen of the display 208. During a commercial transaction, the mobile computer 200 transmits the information to a credit card issuer to effect the payment transaction.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for the near-field wireless device pairing described herein. The non-processor circuits may include, but are not limited to, a radio receiver, a radio transmitter, signal drivers, clock circuits, power source circuits, and user input devices. As such, these functions may be interpreted as steps of a method to perform the near-field wireless device pairing described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

What is claimed is:

1. A mobile computer comprising:
a memory for storing a software application;
a processor coupled to the memory for executing the software application;
a display coupled to the processor for graphically displaying information generated by the software application;
a keypad coupled to the processor for receiving input from a user, the keypad positioned adjacent to the display; and
a RFID antenna embedded in a portion of the keypad, the RFID antenna comprising at least one conductor forming at least one loop for communicating with a RFID device to receive information from the RFID device.

2. The mobile computer of claim 1, wherein the RFID antenna is configured to write information to the RFID device.

3. The mobile computer of claim 1, wherein the RFID device comprises a RFID tag.

4. The mobile computer of claim 1, wherein the at least one conductor substantially surrounds the keypad.

5. The mobile computer of claim 1, wherein the at least one conductor comprises a pair of conductors that form first and second concentric loops.

6. The mobile computer of claim 1, wherein the at least one conductor is positioned proximate to a top surface of a plurality of keycaps of the keypad.

7. The mobile computer of claim 1 further comprising a housing for supporting the memory, the processor, the display, the keypad, and the RFID antenna.

8. The mobile computer of claim 1, wherein the display comprises a liquid crystal display (LCD).

9. The mobile computer of claim 1, wherein the at least one conductor comprises a wire.

10. The mobile computer of claim 1, wherein the at least one conductor comprises a conductive trace deposited on a surface of the keypad.

11. The mobile computer of claim 1, further comprising a RFID transceiver coupled to the RFID antenna for communicating wirelessly with the RFID device.

12. A keypad comprising:
a keypad frame;
a plurality of keycaps supported by the keypad frame;
a circuit board comprising a plurality of contact domes, each of the keycaps being aligned with a corresponding contact dome on the circuit board; and
a RFID antenna comprising at least one conductor forming at least one loop that substantially surrounds the plurality of keycaps, the at least one conductor mechanically coupled to the keypad frame.

13. The keypad of claim 12, wherein the RFID antenna is configured to read information from and write information to a RFID tag.

14. The keypad of claim 13, wherein the RFID tag is embedded in an RFID device.

15. The keypad of claim 12, wherein the at least one conductor comprises a pair of conductors that form first and second concentric loops.

16. The keypad of claim 12, wherein the at least one conductor is positioned proximate to a top surface of the plurality of keycaps of the keypad.

17. The keypad of claim 12 further comprising a housing for supporting the keypad frame, the plurality of keycaps, the circuit board, and the RFID antenna.

18. The keypad of claim 12, wherein the at least one conductor comprises a wire.

19. The keypad of claim 12, wherein the at least one conductor comprises a conductive trace deposited on a surface of the frame.

20. The keypad of claim 12, further comprising a RFID transceiver coupled to the RFID antenna for communicating wirelessly with a RFID device.
